(19) United States
(12) Patent Application Publication
(10) Pub. No.: US 2011/0111311 A1
(43) Pub. Date: May 12, 2011

(54) SOLID OXIDE FUEL CELL

(76) Inventors: Motoki Sato, Ibaraki (JP); Takashi Miyazawa, Ibaraki (JP); Naoya Murakami, Ibaraki (JP)

(21) Appl. No.: 12/934,703

(22) PCT Filed: Mar. 27, 2009
(86) PCT No.: PCT/JP2009/001387

§ 371 Date: Dec. 20, 2010

(30) Foreign Application Priority Data
Mar. 28, 2008 (JP) 2008-087822

(51) Int. Cl. H01M 8/04; H01M 8/06

(52) U.S. Cl. 429/413

(57) ABSTRACT

An object of the present invention is to provide a fuel cell which prevents an unreformed fuel gas from being supplied to a fuel electrode at start-up without requiring a storage chamber for hydrogen gas and the like. In order to achieve this object, the fuel cell includes: a fuel cell stack (10) which laminates a power generation cell (16), which includes a fuel electrode layer (12), an oxidant electrode layer (13), and a solid electrolyte layer (11) sandwiched therebetween, by interposing a separator (2) between the power generation cells (16); a fuel gas supply line (40) which interposedly provides a reformer (45) supplying a reformed gas to the stacks (10); and a steam supply line (60) which interposedly provides a steam generator (41) supplying steam to an upstream side of the reformer on the fuel gas supply line, wherein start-up reformers (46a) and (46b) are interposedly provided on a downstream side of a connection portion to the steam supply line on the fuel gas supply line; start-up steam generators (43a) and (43b) are interposedly provided on the steam supply line; and the start-up reformer and the start-up steam generator are installed at a position facing start-up heating means (6a) to (6d) which operate at start-up.

### TECHNICAL FIELD

The present invention relates to a solid oxide fuel cell having a power generation cell which includes a fuel electrode layer, an air electrode layer, and a solid electrolyte layer sandwiched therebetween.

### BACKGROUND ART

In recent year, a fuel cell which directly converts the chemical energy of fuel to electrical energy has gained attention as a highly efficient and clean power generating apparatus. The fuel cell has a fuel cell stack which laminates a power generation cell, which includes an air electrode layer (cathode), a fuel electrode layer (anode), and a solid electrolyte layer which is made of an oxide ion conductor and is sandwiched between the air electrode layer and the fuel electrode layer, by interposing a separator between the power generation cells.

At power generation, an oxidant (oxygen) is supplied as a reactant gas to an air electrode layer side, and a reformed gas (H₂, CO, CO₂, H₂O, etc.) obtained by reforming a fuel gas (town gas containing CH₄ etc.) by a reformer is supplied to a fuel electrode layer side. Each of the air electrode layers and fuel electrode layers is configured as a porous layer so as to allow the reactant gas to reach the interface with the solid electrolyte layer.

Thus, in the power generation cell, the oxygen gas supplied to the air electrode layer side reaches near the interface with the solid electrolyte layer through pores in the air electrode layer, and receives electrons from the air electrode layer to be ionized into oxide ions (O²⁻). Then, the oxide ions diffusively move through the solid electrolyte layer toward the fuel electrode layer. The oxide ions which reach near the interface with the fuel electrode layer react with a reformed gas to produce a reaction product (H₂O, CO₂, and the like) and emit electrons to the fuel electrode layer. Note that the electrons generated by electrode reaction can be extracted as an electromotive force by an external load through a different route.

However, the fuel cell has a problem in that at power generation, a high temperature atmosphere occurs around the fuel cell stack and thus the reformer can sufficiently reform the fuel gas by absorbing the surrounding heat, whereas at start-up, the reformer cannot perform a reformation reaction, namely, an endothermic reaction and thus an unreformed fuel gas is supplied to the fuel electrode layer. Such a supply of an unreformed fuel gas to the fuel electrode layer does not contribute to power generation, but instead, a reducing gas such as hydrogen gas is not supplied and thus the fuel electrode layer is oxidized by oxygen in the air in the external atmosphere, thereby causing a problem that the fuel electrode layer is peeled off from the solid electrolyte layer by expansion and contraction thereof.

For this reason, at start-up, instead of the above fuel gas, nitrogen gas and hydrogen gas are supplied to the power generation cell of each fuel cell stack so as to maintain the fuel electrode layer at least in a non-oxidizing atmosphere, preferably in a reducing atmosphere; and an electrode reaction is caused by the reaction between the hydrogen gas and the above oxygen. For this purpose, the fuel cell generally has storage chambers for nitrogen gas and hydrogen gas therein (see Patent Document 1), thereby causing a problem that the entire apparatus becomes excessively large.
Patent Document 1: Japanese Patent Laid-Open No. 05-054901

### DISCLOSURE OF THE INVENTION

In view of the above, the present invention has been made, and an object of the present invention is to provide a solid oxide fuel cell which can efficiently operate by preventing an unreformed fuel gas from being supplied to a fuel electrode at start-up without requiring a storage chamber.

More specifically, a solid oxide fuel cell according to the present invention comprises: a fuel cell stack which laminates a power generation cell, which includes a fuel electrode layer disposed on one surface of a solid electrolyte layer and an air electrode layer disposed on the other surface thereof, by interposing a separator between the power generation cells; a reformer which introduces a fuel gas together with steam therein and generates a reformed gas by absorbing heat released from the fuel cell stack at power generation; a fuel gas supply line which interposedly provides the reformer and supplies the reformed gas to the fuel cell stack; a steam generator which introduces water therein and generates steam by absorbing heat released from the fuel cell stack at power generation; and a steam supply line which interposedly provides the steam generator and supplies the steam to an upstream side of the reformer on the fuel gas supply line, wherein a start-up reformer is interposedly provided on a downstream side from a connection portion to the steam supply line on the fuel gas supply line and a start-up steam generator is interposedly provided on the steam supply line, and the start-up reformer and the start-up steam generator are installed at a position facing start-up heating means which operates at start-up.

Moreover, in the solid oxide fuel cell, for example, the fuel cell stack is installed in an internal can body together with the reformer, the steam generator, the start-up reformer, and the start-up steam generator, and a heat insulating material is provided on an outer periphery of the internal can body; a plurality of the fuel cell stacks are two-dimensionally provided in the internal can body and a plurality of the fuel cell stacks are provided in upward and downward directions, and thereby, the internal can body has a plurality of fuel cell stack groups made up of the plurality of fuel cell stacks disposed in the upward and downward directions; and the reformer is interposed between the fuel cell stack groups.

Moreover, in the solid oxide fuel cell, for example, the start-up reformer is interposedly provided on a downstream side of the reformer on the fuel gas supply line and the start-up steam generator is interposedly provided on a downstream side of the steam generator on the steam supply line.

Moreover, in the solid oxide fuel cell, for example, the start-up heating means is installed in the internal can body.

According to the solid oxide fuel cell of the present invention, a start-up reformer is interposedly provided on a fuel gas supply line and a start-up steam generator is interposedly provided on a steam supply line, and the start-up reformer and the start-up steam generator are provided at a position facing start-up heating means; and thus even at start-up time when the entire apparatus temperature is low, the start-up heating means can be used to heat the start-up reformer and the start-up steam generator; and thus, even if steam cannot be generated by the steam generator and fuel gas cannot be reformed by the reformer, a supply of a fuel gas to the fuel gas supply line allows the steam to be generated by the start-up steam generator and the fuel gas to be reformed by the start-up reformer.

Therefore, at start-up, fuel gas can be supplied as is to the fuel gas supply line without the need to supply hydrogen and nitrogen from inlet ports, thereby preventing the entire apparatus from being excessively large by installing storage chambers for hydrogen and nitrogen.

Further, if the fuel cell stack is installed in the internal can body together with the start-up reformer and the like, and a heat insulating material is provided on an outer periphery of the internal can body, the temperature inside the internal can body efficiently increases at start-up by the heat released from the start-up heating means and an electrode reaction, which allows oxygen gas and reformed gas to be heated, and thus can shorten the time until power generation starts.

Furthermore, if the internal can body has a plurality of fuel cell stack groups made up of a plurality of fuel cell stacks disposed in the upward and downward directions, and the reformer is interposed between the fuel cell stack groups, the reformer is efficiently heated by the heat released from the fuel cell stack, and thus the present invention can prevent an excessive energy from being used to activate the fuel cell by shortening the time from activation to power generation start and reducing the operation time of the start-up heating means. In addition, the reformation reaction in the reformer is an endothermic reaction and thus, the difference in temperature distribution inside the internal can body can be reduced by installing the reformer at a position interposed between the fuel cell stacks having the highest temperature in the internal can body and the solid electrolyte layer can also be prevented from being broken due to thermal strain caused by a temperature difference.

In addition, if the start-up reformer is interposedly provided on a downstream side of the reformer on the fuel gas supply line, the start-up heating means for the start-up reformer can instantaneously adjust the heating temperature according to the change in temperature inside the internal can body. Likewise, if the start-up steam generator is interposedly provided on a downstream side of the steam generator on the steam supply line, the start-up heating means for the start-up steam generator can instantaneously adjust the heating temperature. Therefore, the fuel cell can be activated using minimum energy without excessively heating the reformed gas supplied to the fuel cell stack.

The start-up heating means installed in the internal can body can efficiently heat the start-up reformer and the start-up steam generator.

### BRIEF DESCRIPTION OF THE DRAWINGS

FIG. 1 is a plan view of a flat plate solid oxide fuel cell according to the present invention;

FIG. 2 is a sectional view along line II-II of FIG. 1;

FIG. 3 is a sectional view along line III-III of FIG. 1;

FIG. 4 is an explanatory drawing of a fuel gas supply line in the flat plate solid oxide fuel cell according to the present invention;

FIG. 5 is a partial explanatory drawing of a fuel cell stack 10;

FIG. 6 is a plan view of a separator 2;

FIG. 7A is an explanatory drawing of a start-up air heater 51; and

FIG. 7B is an explanatory drawing of a start-up air heater 51.

### DESCRIPTION OF SYMBOLS

1a to 1d Fuel cell stack group
10 Fuel cell stack
11 Solid electrolyte layer
12 Fuel electrode layer
13 Air electrode layer (oxidant electrode layer)
16 Power generation cell
41 Steam generator
43a, 43b Start-up steam generator
45 Reformer
46a, 46b Start-up reformer
40 Fuel gas supply line
48 Fuel gas manifold
60 Steam supply line

### BEST MODE FOR CARRYING OUT THE INVENTION

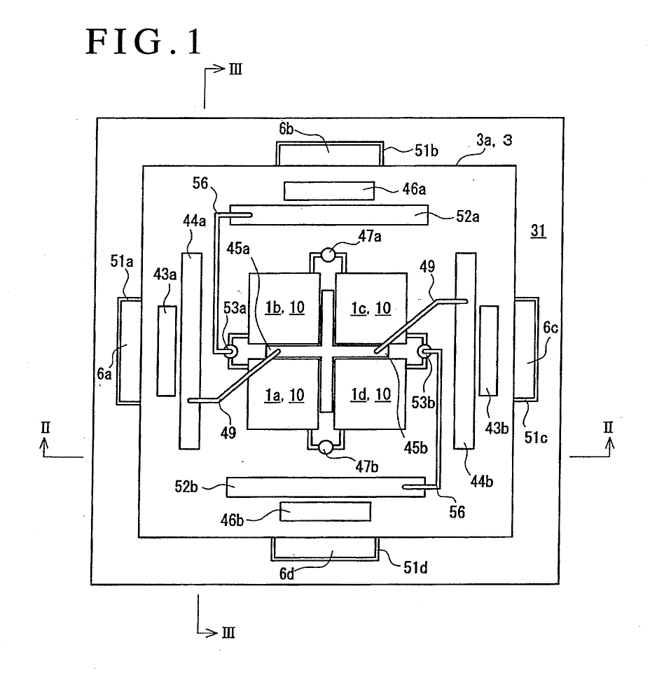

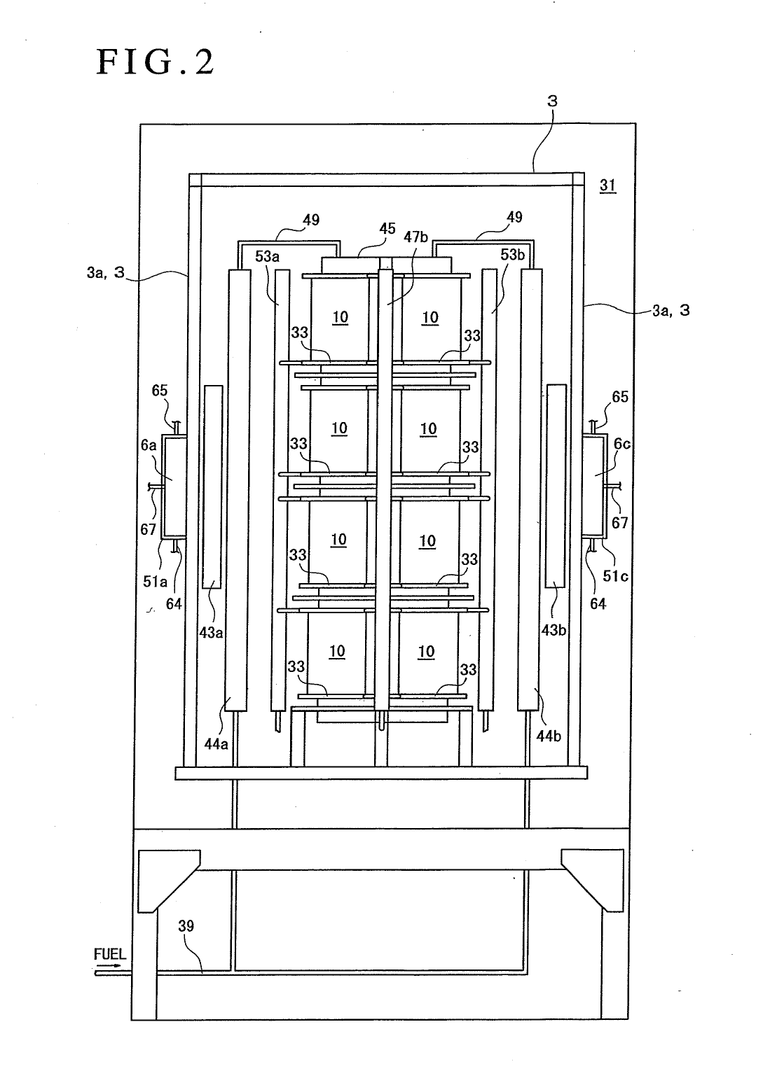

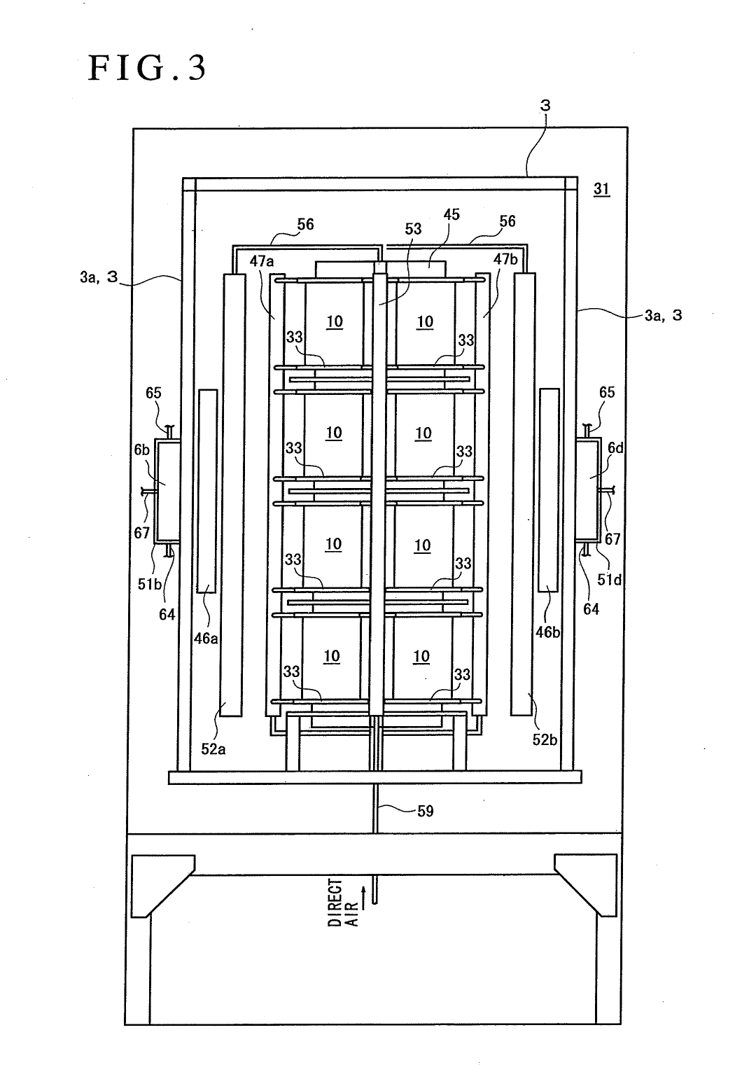

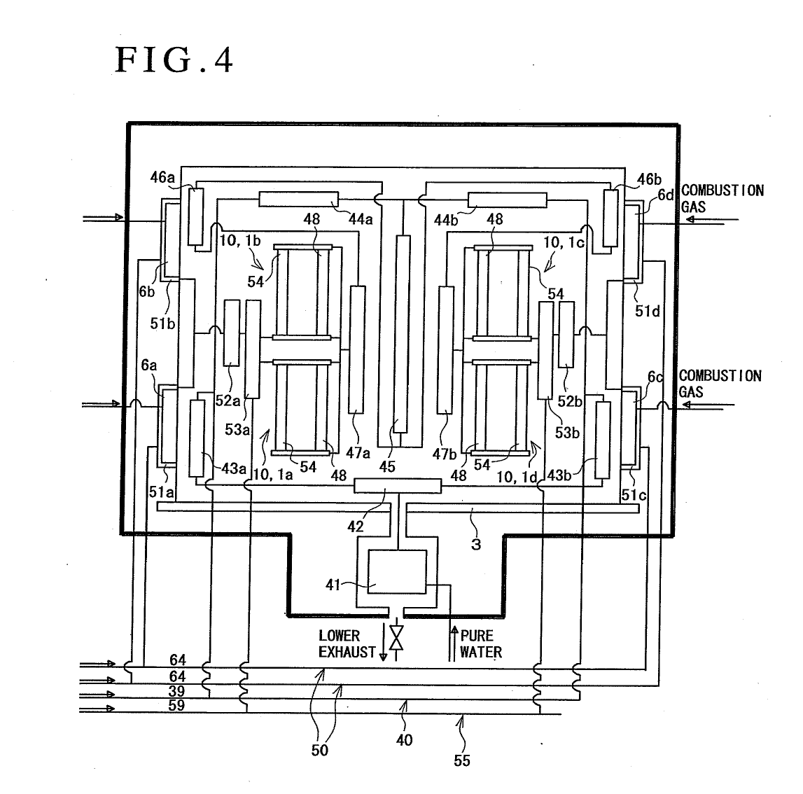

Hereinafter, embodiments of a flat plate solid oxide fuel cell according to the present invention will be described by referring to FIGS. 1 to 7B.

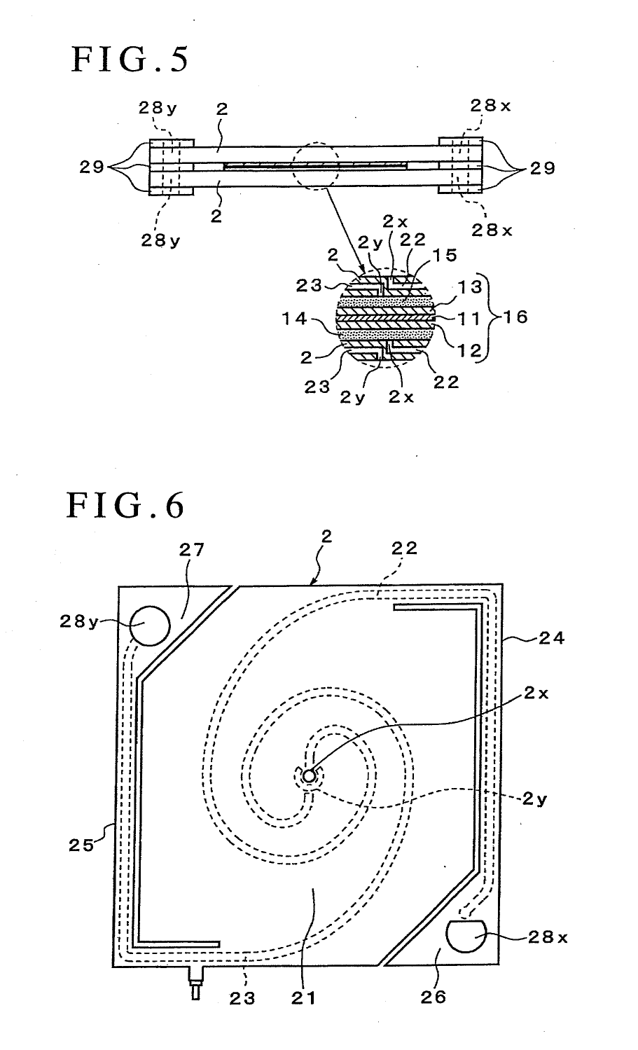

As illustrated in FIG. 5, a fuel cell according to the present embodiment is configured to have a fuel cell stack 10 which has an external appearance of a substantially rectangular columnar shape and laminates a plurality of power generation cells 16, which includes a fuel electrode layer 12 disposed on one surface of a solid electrolyte layer 11 and an air electrode layer (oxidant electrode layer) 13 disposed on the other surface thereof, by interposing a separator 2 between the power generation cells.

In addition, a fuel electrode current collector 14 is interposed between the fuel electrode layer 12 and the separator 2 of the power generation cell 16 and an air electrode current collector 15 is interposed between the air electrode layer 13 and the separator 2.

Here, the solid electrolyte layer 11 is formed into a discoid shape with yttria-stabilized zirconia (YSZ) or lanthanum gallate (LaGaO₃) material. The fuel electrode layer 12 is formed into a circular shape with a metal such as Ni or a cermet such as Ni—YSZ. The air electrode layer 13 is formed into a circular shape with LaMnO₃, LaCoO₃, or the like. The fuel electrode current collector 14 is formed into a discoid shape with a sponge-like porous sintered metal plate such as Ni. The air electrode current collector 15 is formed into a discoid shape with a sponge-like porous sintered metal plate such as Ag.

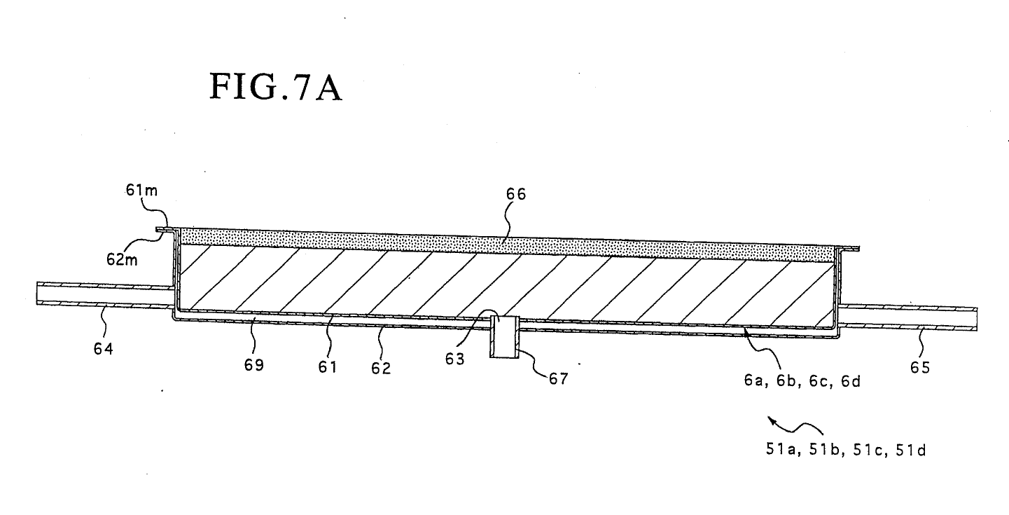

Further, as illustrated in FIG. 6, the separator 2 is made of a substantially square stainless plate with a thickness of several mm and is configured to include the above described power generation cell 16; a central separator body 21 laminating each of the current collectors 14 and 15; and a pair of separator arms 24 and 25 which extend in a plane direction from the separator body 21 and support a mutually facing edge portion of the separator body 21 at two position.

The separator body 21 has a function of electrically connecting between the power generation cells 16 through the current collectors 14 and 15 as well as a function of supplying reactant gas to each power generation cell 16. The separator body 21 includes a fuel gas path 22 which introduces fuel gas from an edge portion of the separator 2 to the inside thereof and ejects the fuel gas from a discharge outlet 2x in a center portion of a surface facing the fuel electrode current collector 14 of the separator 2; and an oxidant gas path 23 which introduces oxidant gas (air) from an edge portion of the separator 2 and ejects the oxidant gas from a discharge outlet 2y in a center portion of a surface facing the air electrode current collector 15 of the separator 2.

Each of the separator arms 24 and 25 has a structure having flexibility in the lamination direction as a long strip shape extending along an outer periphery of the separator body 21 toward a mutually facing corner portion having a slight space therebetween and a pair of gas holes 28x and 28y penetrating through in the plate thickness direction are provided on end portions 26 and 27 of the separator arms 24 and 25.

One gas hole 28x is communicatively connected to the fuel gas path 22 of the separator 2 and the other gas hole 28y is communicatively connected to the oxidant gas path 23 of the separator 2, so as to supply fuel gas and oxidant gas to each surface of the respective electrodes 12 and 13 of each power generation cell 16 through the respective gas paths 22 and 23 from the respective gas holes 28x and 28y.

Then, a power generation cell 16 and current collectors 14 and 15 are interposed between the main bodies 21 of each separator 2 and an insulating manifold ring 29 is interposed between the gas holes 28x and 28y of each separator 2, thereby providing a fuel cell stack 10 having an external appearance of a substantially rectangular columnar shape which has a fuel gas manifold 48 including the gas hole 28x and the manifold ring 29; and an air manifold 54 including the gas hole 28y and the manifold ring 29.

A large number of fuel cell stacks 10 configured in this manner are provided in a center portion of the internal can body 3 enclosed by a rectangular tubular side plate 3a, a top plate and a bottom plate so as to form a plurality of rows (two rows in the present embodiment) and a plurality of columns (two columns in the present embodiment) in horizontal and vertical directions and each fuel cell stack 10 is placed on a rack 33 with its outer peripheral surface parallel to the side plate 3a and having a space therebetween. Thereby, a large number (four in the present embodiment) of fuel cell stacks are provided in a plane direction and further a plurality of (four in the present embodiment) fuel cell stacks are provided in an up/down height direction. Thus, the internal can body 3 has fuel cell stack groups 1a to 1d including a plurality of fuel cell stacks 10 provided in an up/down height direction.

Further, a reformer 45 with a cross-shaped cross section is provided in a space between the stack groups 1a to 1d. The reformer 45 has a height extending from between the uppermost fuel cell stacks 10 to between the lowermost fuel cell stacks 10.

Meanwhile, two fuel heat exchangers 44a and 44b made of a rectangular solid shaped housing are provided along one opposite side plate 3a of the internal can body 3. The fuel heat exchangers 44a and 44b are arranged so as to face two stack groups 1a and 1b, or 1c and 1d respectively. Further, a fuel pipe 39 having a fuel gas inlet port outside the internal can body 3 is connected to each inlet side of the fuel heat exchangers 44a and 44b and each outlet side of the fuel heat exchangers 44a and 44b is connected to the reformer 45.

For this reason, on a ceiling surface of the reformer 45, a fuel pipe 49 is connected to an end portion on a side of the fuel heat exchangers 44a and 44b of the wing portions 45a and 45b extending in a detaching/attaching direction from the fuel heat exchangers 44a and 44b and the other end portion of the fuel pipe 49 is connected to an upper portion of the fuel heat exchangers 44a and 44b.

Further, an outer periphery of the internal can body 3 is covered with the heat insulating material 31. The four side plates 3a have start-up infrared burners 6a to 6d for releasing heat inside the can body with its back surface side buried in the heat insulating material 31 at a center portion in the width direction and at a center portion in upward and downward directions of the respective side plates 3a.

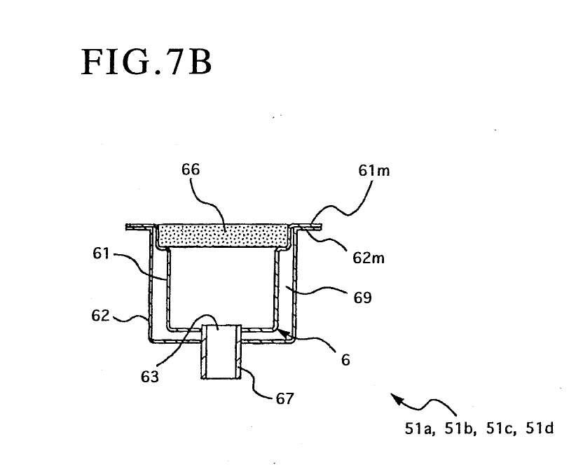

As illustrated in FIGS. 7A and 7B, each of these four infrared burners 6a to 6d is configured to include a SUS-made inner box 61 formed into an elongated box-like shape; a porous ceramic combustion plate 66 mounted on a front opening portion thereof; and a supply pipe 67 which is connected to a gas inlet port 63 formed on a rear portion of the inner box 61 and supplies a burner combustion gas. The inner box 61 is overlappedly placed in a SUS-made outer case 62 with the same shape as but slightly larger than the inner box 61 located on the rear portion thereof. The inner box 61 and the outer case 62 are configured such that an air passage 69 is formed therebetween by integrally overlapping and fixing flanges 61m and 62m provided on the respective peripheral edge portions thereof.

In addition, an air pipe 64 having an air inlet port outside the internal can body 3 is connected to an inlet port of the air passage 69 on one longitudinal end portion of the outer case 62; and the other end portion of the air passage 69 is connected to an inlet side of the later described air heat exchangers 52a and 52b through an air pipe 65.

Thereby, when a mixed gas is supplied from the supply pipe 67, the inner box 61 functions as a mixed gas chamber for combustion filled with mixed gas. Then, at start-up, when air is supplied from the air pipe 64 to the air passage 69, the air in the air passage 69 is heated. Each of the start-up air heaters 51a to 51d are configured of each of the infrared burners 6a to 6d and the outer case 62. Note that each outer case 62 functions as a cooling mechanism for each infrared burner 6.

Further, start-up steam generators 43a and 43b made of a rectangular solid shaped housing are provided between the combustion plate 66 of the infrared burners 6a and 6c and the above mentioned fuel heat exchangers 44a and 44b. The start-up steam generators 43a and 43b are arranged in order to efficiently absorb radiation heat from the combustion plate 66, specifically, in a position overlapped with the combustion plate 66 in a side view, particularly, according to the present embodiment, in a position where the combustion plate 66 is positioned at a center portion of the steam generators 43a and 43b in the upward and downward directions.

Each of the start-up steam generators 43a and 43b is connected to a fuel pipe 39 through a steam pipe whose outlet side is not illustrated and the steam buffer tank 42 is connected to each inlet side with a steam generator 41 provided on an upstream side.

On the other hand, two air heat exchangers 52a and 52b made of a rectangular solid shaped housing are provided along the other opposite side plate 3a of the internal can body 3. The air heat exchangers 52a and 52b are arranged so as to face two fuel cell stack groups 1b and 1c, or 1d and 1a respectively. Further, the other end portion of the air pipe 56 connected to an upper portion of the air heat exchangers 52a and 52b is connected to the air buffer tanks 53a and 53b supplying oxidant gas to the fuel cell stack groups 1a and 1b, or 1c and 1d. Therefore, the air heat exchangers 52a and 52b are connected to the respective inlet sides of the air buffer tanks 53a and 53b, and further an air pipe 59 having an air inlet port outside the internal can body 3 is connected thereto.

Further, start-up reformers 46a and 46b made of a rectangular solid shaped housing are provided between each of the air heat exchangers 52a and 52b and the combustion plate 66 of the infrared burners 6b and 6d. Each of the start-up reformers 46a and 46b is arranged in order to efficiently absorb radiation heat from the combustion plate 66, specifically, in a position overlapped with the combustion plate 66 in a side view, particularly, according to the present embodiment, in a position where the combustion plate 66 is positioned at a center portion of the start-up reformers 46a and 46b in the upward and downward directions. Furthermore, the other end portion of a fuel pipe (not illustrated) connected to an outlet at a lower portion of each reformer 45 is connected to a lower portion of each of the start-up reformers 46a and 46b. The other end portion of a fuel pipe (not illustrated) connected to an outlet at an upper portion of each of the start-up reformers 46a and 46b is connected to the respective fuel buffer tanks 47a and 47b supplying fuel gas to the respective fuel cell stack groups 1b and 1c, or 1d and 1a.

Thus, the fuel gas supply line 40 is configured to include the fuel pipe 39 having a fuel gas inlet port; and other fuel pipes such as the pipe 49 which connects the fuel heat exchangers 44a and 44b, the reformer 45, the start-up reformers 46a and 46b, and the fuel buffer tanks 47a and 47b in the order from the upstream side to the downstream side in series and supplies reformed fuel gas to each fuel cell stack 10. Further, the steam supply line 60 is configured of a steam pipe which connects the steam generator 41, the steam buffer tank 42, and the start-up steam generators 43a and 43b in the order from the upstream side to the downstream side in series and supplies steam to the fuel gas supply line 40.

On the other hand, a start-up air supply line 50 is configured to include an air pipe 64 having an air inlet port; and other air pipes such as pipes 65 and 56 which connect the start-up air heaters 51a to 51d, the air heat exchangers 52a and 52b, and the air buffer tanks 53a and 53b from the upstream side to the downstream side in series and supplies air to each fuel cell stack 10. Further, an operation air supply line 55 is configured to include an air pipe 59 having an air inlet port and an air pipe connecting the air buffer tanks 53a and 53b, and the fuel cell stack 10.

Hereinafter, the operation of the above described solid oxide fuel cell will be described.

When the fuel cell is activated, first, burner fuel gas is supplied to the supply pipe 67 and the infrared burners 6a to 6d are ignited. In parallel to this, fuel gas is supplied from the inlet port of the fuel pipe 39 to the fuel gas supply line 40 and outside air is supplied from the inlet port of the air pipe 64 to the start-up air supply line 50, and steam generator 41 is operated.

Then, the heat released from the combustion plate 66 of the infrared burners 6a to 6d gradually increases the temperature of the fuel cell stack 10 and at the same time increases the temperature inside the internal can body 3. At the same time, by the operation of the steam generator 41, the steam supplied through the steam supply line 60 is heated by the steam buffer tank 42 and is divided into two flows to be supplied to the start-up steam generators 43a and 43b. Then, in the start-up steam generators 43a and 43b, the steam is sufficiently heated by the infrared burners 6a and 6c and is supplied to the fuel gas supply line 40. Then, the steam is mixed with fuel gas on an outlet side of the fuel pipe 39.

Meanwhile, the fuel gas supplied to the fuel gas supply line 40 is divided into two flows on an inlet side of the fuel pipe 39 and each fuel gas flow is mixed with the steam supplied from the steam supply line 60. At the same time, the fuel gas is supplied to the fuel heat exchangers 44a and 44b and is heated indirectly by a temperature atmosphere inside the internal can body 3. Then, the fuel gas is introduced to the reformer 45 from the wing portions 45a and 45b through the fuel pipe 49.

Then, the fuel gas passes through two fuel pipes (not illustrated) in a state partially reformed by the reformer 45 and is supplied to the start-up reformers 46a and 46b in which the partially reformed fuel gas is directly heated by radiation heat of the infrared burners 6b and 6d. Then, the reformed fuel gas sufficiently reformed by the start-up reformers 46a and 46b is supplied to the fuel buffer tanks 47a and 47b. Then, the reformed gas is distributively supplied to a fuel gas manifold 48 of each fuel cell stack 10 of the fuel cell stack groups 1b and 1c, or 1d and 1a from the fuel buffer tanks 47a and 47b. Then, the reformed gas passes through a fuel gas path 22 of the separator 2 from the fuel gas manifold 48 and reaches a discharge outlet 2x. Then, the reformed gas diffusively moves from the discharge outlet 2x through the fuel electrode current collector 14, and further moves through the fuel electrode layer 12 toward the solid electrolyte layer 11 side.

On the other hand, the air supplied to the start-up air supply line 50 is supplied from the air pipe 64 to each of the start-up air heaters 51a to 51d. Then, the air cools the infrared burners 6a to 6d and is directly heated thereby. Then, the air flows are joined and indirectly heated by the two air heat exchangers 52a and 52b. Then, the air is supplied to air buffer tanks 53a and 53b.

Then, the air is distributively supplied from the air buffer tanks 53a and 53b to an air manifold 54 of each fuel cell stack 10 of the fuel cell stack groups 1a and 1b, or 1c and 1d. Then, the air passes from the air manifold 54 through an oxidant gas path 23 of the separator 2 and reaches a discharge outlet 2y. Then, the air diffusively moves from the discharge outlet 2y through the air electrode current collector 15. Further, in the air electrode layer 13, oxygen in the air receives electrons to form oxide ions. The oxide ions diffusively move through the solid electrolyte layer 11 toward the fuel electrode layer 12. Thus, the oxide ions which reach near the interface with the fuel electrode layer 12 react with the reformed gas to produce a reaction product such as steam and emit electrons to the fuel electrode layer 12.

Such electrode reaction speed is slow because at start-up, the air temperature and the reformed gas temperature are low and the temperature of the fuel cell stack 10 is low. However, the electrode reaction speed increases with an increase in temperature inside the internal can body 3.

Thus, at power generation when the temperature inside the internal can body 3 increases, the above described air supply is switched from the start-up air supply line 50 to the operation air supply line 55, namely, from the air pipe 64 to the air pipe 59 and the operation of the infrared burners 6a to 6d is stopped.

Then, the air is divided into two flows in the air pipe 59 and supplied to the two air buffer tanks 53a and 53b. In the same manner as at start-up, the air is distributively supplied from the air buffer tanks 53a and 53b to the air manifold 54 of each fuel cell stack 10 of the fuel cell stack groups 1a and 1b, or 1c and 1d. Then, the air reacts with the reformed fuel gas sufficiently reformed by the reformer 45 near the interface with the fuel electrode layer 12 of the solid electrolyte layer 11.

At this time, even if the fuel gas is not sufficiently heated by the start-up steam generators 43a and 43b and the start-up reformers 46a and 46b because the operation of the infrared burners 6a to 6d is stopped, the fuel gas is sufficiently heated by the reformer 45 and the steam buffer tank 42. Thus, the fuel gas becomes reformed gas and reacts with oxide ions as described above.

According to the solid oxide fuel cell of the present embodiment, the start-up reformers 46a and 46b are interposedly provided on the fuel gas supply line 40 and the start-up steam generators 43a and 43b are interposedly provided on the steam supply line 60 and the start-up reformers and start-up steam generators are installed at a position facing the infrared burners 6a to 6d. Thus, even at start-up when the entire apparatus temperature is low, the burners 6a to 6d can be used to heat the start-up reformers 46a and 46b and the start-up steam generator 43a and 43b. For this reason, even if steam is not generated by the steam generator 41 and fuel gas is not reformed by the reformer 45, a supply of fuel gas to the inlet port of the fuel gas supply line 40 allows the steam to be generated by the start-up steam generators 43a and 43b and the fuel gas to be reformed by the start-up reformers 46a and 46b.

Moreover, at start-up, the fuel gas can be supplied as is to the fuel gas supply line 40 without the need to supply hydrogen and nitrogen from the inlet port, thereby preventing the entire apparatus from being excessively large by installing storage chambers for hydrogen and nitrogen.

In addition, because the start-up reformers 46a and 46b are interposedly provided on the downstream side of the reformer 45, the infrared burners 6b and 6d for the start-up reformers 46a and 46b can instantaneously adjust the heating temperature according to the change in temperature inside the internal can body 3. Likewise, the infrared burners 6a and 6c for the start-up steam generators 43a and 43b can instantaneously adjust the heating temperature. Therefore, the fuel cell can be activated using minimum energy without excessively heating the reformed gas supplied to each fuel cell stack 10.

### INDUSTRIAL APPLICABILITY

As described above, the present invention can provide a solid oxide fuel cell which can efficiently operate by preventing an unreformed fuel gas from being supplied to a fuel electrode at start-up without requiring a storage chamber for hydrogen gas and the like.

1. A solid oxide fuel cell comprising:
a fuel cell stack which laminates a power generation cell, which includes a fuel electrode layer disposed on one surface of a solid electrolyte layer and an oxidant electrode layer disposed on the other surface thereof, by interposing a separator therebetween;
a reformer which introduces a fuel gas together with steam therein and generates a reformed gas by absorbing heat released from the fuel cell stack at power generation;
a fuel gas supply line which interposedly provides the reformer and supplies the reformed gas to the fuel cell stack;
a steam generator which introduces water therein and generates steam by absorbing heat released from the fuel cell stack at power generation; and
a steam supply line which interposedly provides the steam generator and supplies the steam to an upstream side of the reformer on the fuel gas supply line,
wherein a start-up reformer is interposedly provided on a downstream side from a connection portion to the steam supply line on the fuel gas supply line and a start-up steam generator is interposedly provided on the steam supply line, and the start-up reformer and the start-up steam generator are installed at a position facing start-up heating means which operates at start-up.

2. The solid oxide fuel cell according to claim 1, wherein
the fuel cell stack is installed in an internal can body together with the reformer, the steam generator, the start-up reformer, and the start-up steam generator, and a heat insulating material is provided on an outer periphery of the internal can body;
a plurality of the fuel cell stacks are two-dimensionally provided in the internal can body and a plurality of the fuel cell stacks are provided in upward and downward directions, and thereby the internal can body has a plurality of fuel cell stack groups made up of the plurality of fuel cell stacks disposed in the upward and downward directions; and
the reformer is interposed between the fuel cell stack groups.

3. The solid oxide fuel cell according to claim 1, wherein the start-up reformer is interposedly provided on a downstream side of the reformer on the fuel gas supply line and the start-up steam generator is interposedly provided on a downstream side of the steam generator on the steam supply line.

4. The solid oxide fuel cell according to claim 1, wherein the start-up heating means is installed in the internal can body.
